(19) United States
(12) Patent Application Publication
(10) Pub. No.: US 2011/0296444 A1
(43) Pub. Date: Dec. 1, 2011

(54) CUSTOMER PREMISES EQUIPMENT AND METHOD FOR PROCESSING COMMANDS

(75) Inventor: CHIH-YUAN HUANG, Tu-Cheng (TW)

(73) Assignee: HON HAI PRECISION INDUSTRY CO., LTD., Tu-Cheng (TW)

(21) Appl. No.: 13/069,389

(22) Filed: Mar. 23, 2011

(30) Foreign Application Priority Data
May 31, 2010 (CN) 201010186814.0

(51) Int. Cl. G06F 13/00; G06F 9/44

(52) U.S. Cl. 719/330

(57) ABSTRACT

A customer premises equipment (CPE) receives a remote procedure call (RPC) command with at least one search condition from an auto-configuration server (ACS). The at least one search condition includes at least one parameter with at least one parameter value. The CPE searches a data model to find at least one instance ID corresponding to the at least one search condition, and replaces the at least one search condition of the RPC command with the at least one found instance ID. The CPE executes the RPC command with the at least one found instance ID.

### BACKGROUND

1. Technical Field

The present disclosure relates to network communications, and more particularly to a customer premises equipment (CPE) and a method for processing commands.

2. Description of Related Art

Technical Report 069 (TR-069) is a DSL forum technical specification entitled CPE WAN Management Protocol (CWMP). TR-069 is intended for a communication between a customer premises equipment (CPE) and an auto-configuration server (ACS). The CPE has a data model defined by the DSL forum. The ACS can use remote procedure call (RPC) commands to manage the data model of the CPE so as to manage the CPE. The data model defined by the DSL forum includes a plurality of objects with a plurality of instances. Each instance includes at least one parameter with a parameter value and an instance identifier (ID) corresponding to the at least one parameter with the parameter value.

If the ACS wants to manage the CPE, the ACS must know at least one instance ID of at least one instance of the data model because the CPE can only execute one RPC command with at least one instance ID. Thus, the ACS must send a RPC command to the CPE to obtain the at least one instance ID of the at least one instance, and then send another RPC command with the at least one obtained instance ID to the CPE so as to manage the CPE.

Therefore, the ACS needs two RPC commands to manage one CPE, which is rather complicated.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of an application environment of one embodiment of a customer premises equipment (CPE) in accordance with the present disclosure;

FIG. 2 is a schematic diagram of one exemplary example of a data model configured in the CPE in accordance with the present disclosure;

FIG. 3 is a schematic diagram of one exemplary example of an object of the data model configured in the CPE in accordance with the present disclosure;

FIG. 4 is a transport diagram of a method for processing commands in accordance with the present disclosure;

FIG. 5 is a schematic diagram of function modules of one embodiment of the CPE in accordance with the present disclosure; and

FIG. 6 is a flowchart of one embodiment of a method for processing commands in accordance with the present disclosure.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

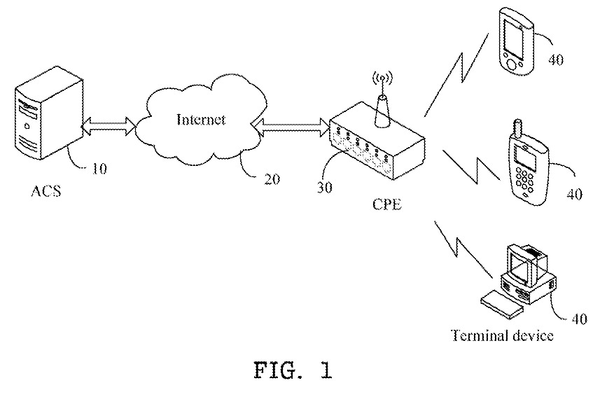

FIG. 1 is a schematic diagram of an application environment of one embodiment of a customer premises equipment (CPE) 30 in accordance with the present disclosure. In one embodiment, the CPE 30 is configured with a data model defined by the DSL Forum. An auto-configuration server (ACS) 10 transmits remote procedure call (RPC) commands to the CPE 30 over the Internet 20 to manage the data model so as to configure and manage the CPE 30. The CPE 30 provides Internet access services for terminal devices 40.

In one non-limiting example, the CPE 30 may be an Internet gateway, a router, a DSL modem, a cable modem etc. The terminal devices 40 may include, for example, mobile phones, notebook computers, tablet computers, etc.

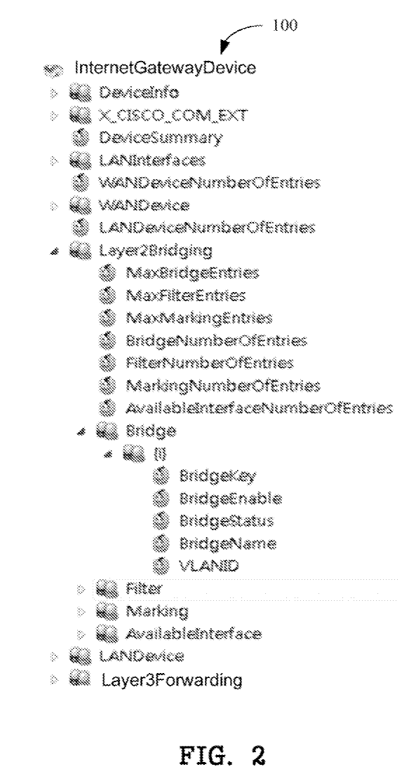

FIG. 2 is a schematic diagram of one exemplary example of a data model 100 configured in the CPE 30 in accordance with the present disclosure. In one exemplary example, the data model 100 is named “InternetGatewayDevice”, which includes a plurality of objects, such as “DeviceInfo”, “X_CISCO_COM_EXT”, “LANInterfaces”, “WANDevice”, “Layer2Bridging”, “LANDevice”, “Laver3Forwarding”, and so on. Each of the objects comprises a plurality of parameters and/or at least one sub-object. For example, the object “Layer2Bridging” includes a plurality of parameters, such as “MaxBridgeEntries”, “MaxFilterEntries” and “AvailableInterfaceNumberOfEntries”, and a plurality of sub-objects, such as “Bridge”, “Filter”, “Marking”, and “AvailableInternet”. The sub-objects each also comprise parameters. For example, the sub-object “Bridge” includes parameters of “BridgeKey”, “BridgeEnable”, “BridgeStatus”, “BridgeName”, and “VLANID”.

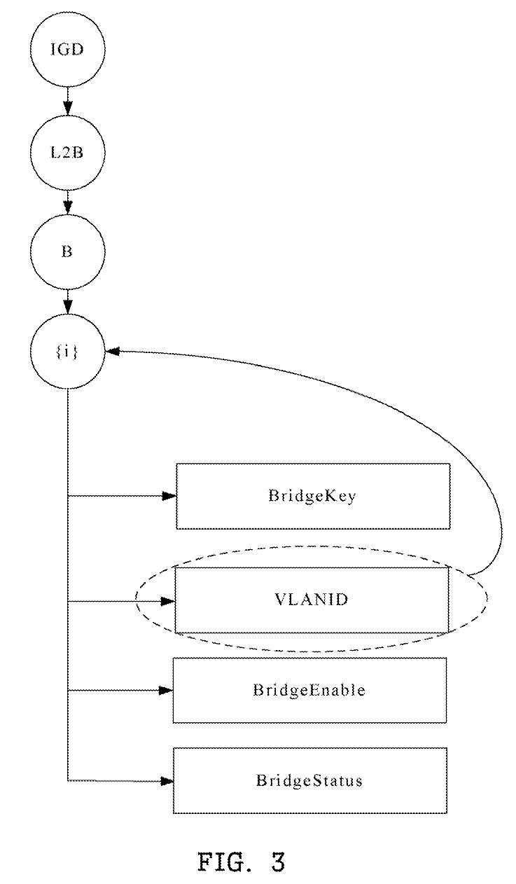

FIG. 3 is a schematic diagram of one exemplary example of an object of the data model 100 configured in the CPE 30 in accordance with the present disclosure. In one exemplary example, a route of the sub-object “Bridge” of FIG. 2 is recorded as “IGD.L2B.B”, which is an abbreviation of the route of “InternetGatewayDevice.Layer2Bridging.Bridge” shown in FIG. 2. The sub-object “Bridge” of FIG. 2 includes parameters of “BridgeKey”, “VLANID”, “BridgeEnable”, and “BridgeStatus”. The parameter “BridgeKey” indicates a key of a bridge mode of a CPE 30. The parameter “VLANID” is an identification of a VLAN that refers to a group of logically networked devices on one or more LANs, such as the terminal devices 40. The parameter “BridgeEnable” indicates that the bridge mode of the CPE 30 is enabled or disabled. The parameter “BridgeStatus” indicates a status of the bridge mode of the CPE 30. If the parameters of the sub-object “Bridge” are set to different parameter values, the sub-object represents different instances. In the exemplary embodiment, the instances are embodied examples of the objects or sub-objects, and each instance is assigned an instance ID by the CPE 30. Thus, each instance includes at least one parameter with at least one parameter value and one instance ID, such as {i} shown in FIG. 3, corresponding to the at least one parameter with the at least one parameter value.

Typically, a RPC command comprises an instance ID corresponding to an instance and parameters accompanying with parameter values of the instance. In the embodiment, the instance ID is replaced with a search condition that matches with one of the parameters accompanying with parameter values. However, the CPE 30 cannot execute RPC commands with the search condition, but can only execute an RPC command with an instance ID. Therefore, in the embodiment, when the CPE 30 receives an RPC command with a search condition, such as {VLANID=2}, the CPE 30 searches the data model 100 to find an instance ID, such as “9999”, which is corresponding to the search condition of {VLANID=2}, and replaces the search condition of {VLANID=2} with the found instance ID of “9999”. Then, the CPE 30 executes the RPC command with the found instance ID.

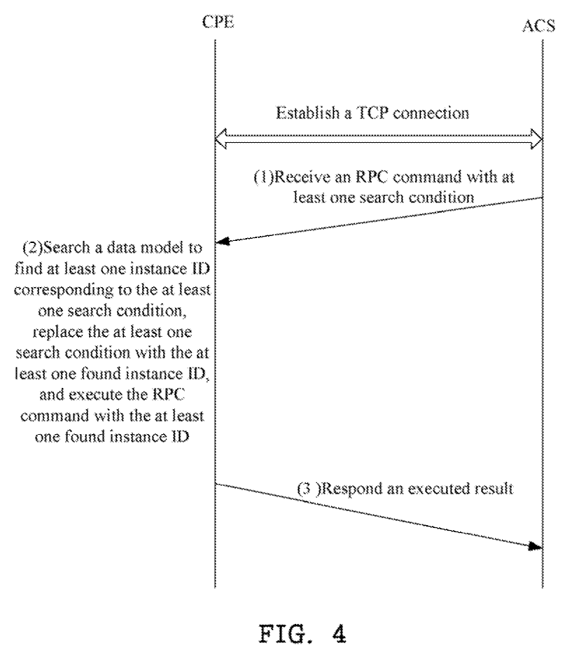

FIG. 4 is a transport diagram of a method for processing commands in accordance with the present disclosure.

In detail, the CPE 30 initially establishes a transport control protocol (TCP) connection with the ACS 10.

Then, the CPE 30 receives an RPC command with at least one search condition from the ACS 10. In one embodiment, the at least one search condition includes at least one parameter accompanying with at least one parameter value.

Afterwards, the CPE 30 searches the data model 100 to find at least one instance ID corresponding to the at least one search condition, and replaces the at least one search condition of the RPC command with the at least one found instance ID, and executes the RPC command with the at least one found instance ID.

Finally, the CPE 30 responds an executed result to the ACS 10.

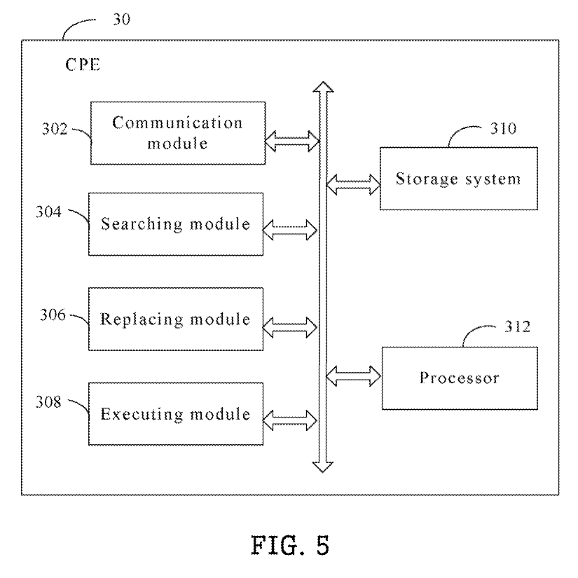

FIG. 5 is a schematic diagram of function modules of one embodiment of the CPE 30 in accordance with the present disclosure. In one embodiment, the CPE 30 includes a communication module 302, a searching module 304, a replacing module 306, an executing module 308, a storage system 310, and at least one processor 312. The modules 302-308 may comprise computerized code in the form of one or more programs that are stored in the storage system 310 (or memory). The computerized code includes commands that are executed by the at least one processor 312 to provide function for modules 302-308.

The communication module 302 is operable to receive an RPC command with at least one search condition from the ACS 10. In one embodiment, the at least one search condition includes symbols “{” and “}” and at least one parameter with at least one parameter value, such as {VLANID=2}.

The searching module 304 is operable to search the data model 100 to find at least one instance ID corresponding to the at least one search condition.

The replacing module 306 is operable to replace the at least one search condition of the RPC command with the at least one found instance ID.

The executing module 308 is operable to execute the RPC command with the at least one found instance ID.

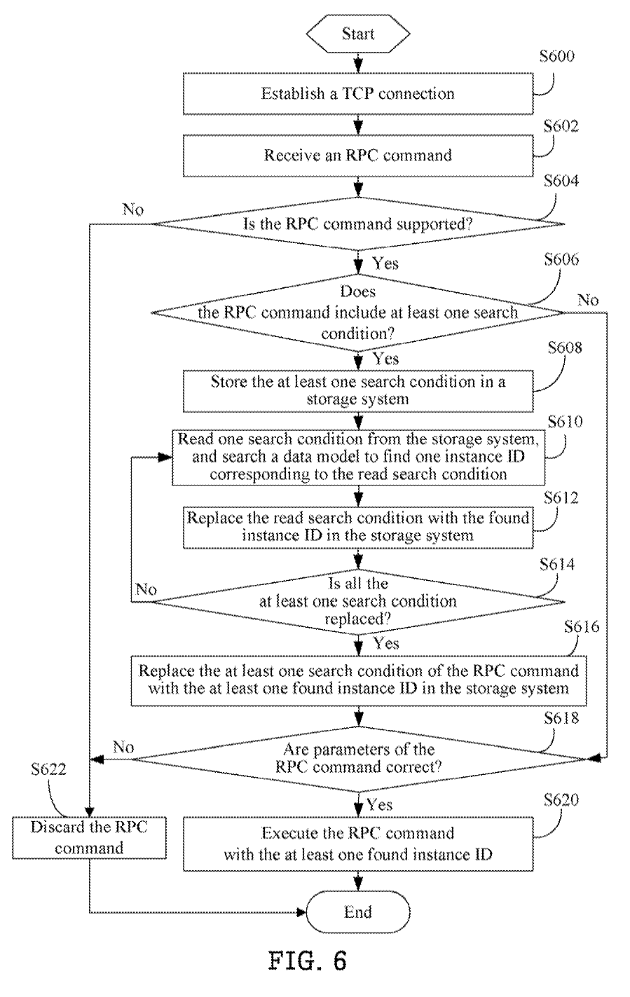

FIG. 6 is a flowchart of one embodiment of a method for processing commands in accordance with the present disclosure. The method is executed by the function modules of FIG. 5. Depending on the embodiment, additional blocks may be added, others deleted, and the ordering of blocks may be changed while remaining well within the scope of the disclosure.

In block S600, the communication module 302 establishes a transport control protocol (TCP) connection with the ACS 10.

In block S602, the communication module 302 receives an RPC command from the ACS 10.

In block S604, the communication module 302 determines whether the RPC command is supported by the CPE 30. In one embodiment, the CPE 30 may only support RPC commands including adding an object, deleting an object, setting parameter values, and getting parameter values.

If the RPC command is not supported by the CPE 30, in block S622, the communication module 302 discards the RPC command.

If the RPC command is supported by the CPE 30, in block S606, the communication module 302 further determines whether the RPC command includes at least one search condition. In one embodiment, the at least one search condition includes at least one parameter with at least one parameter value, such as {VLANID=2} and {PortEnable=1}.

If the RPC command includes at least one search condition, in block S608, the storage system 310 stores the at least one search condition.

In block S610, the searching module 304 reads one search condition from the storage system 310, and searches the data model 100 to find one instance ID corresponding to the read search condition.

In block S612, the replacing module 306 replaces the read search condition with the found instance ID in the storage system 310.

In block S614, the replacing module 306 determines whether all the at least one search condition in the storage system 310 is replaced by at least one found instance ID.

If all the at least one search condition in the storage system 310 is not replaced by the at least one found instance ID, going back to block S610, the searching module 304 reads another search condition from the storage system 310.

If all the at least one search condition in the storage system 310 is replaced by the at least one found instance ID, in block S616, the replacing module 306 replaces the at least one search condition of the RPC command with the at least one found instance ID in the storage system 310.

In block S618, the executing module 308 determines whether parameters of the RPC command with the at least one found instance ID are correct.

If the parameters of the RPC command with the at least one found instance ID are not correct, in block S622, the executing module 308 discards the RPC command with the at least one found instance ID.

If the parameters of the RPC command with the at least one found instance

ID are correct, in block S620, the executing module 308 executes the RPC command with the at least one found instance ID.

For example, it is assumed that the at least one search condition is {VLANID=2}, the at least one instance ID corresponding to {VLANID=2} is 9999, and the RPC command with at least one search condition is “InternetGatewayDevice.Layer2Bridging.Bridge.{VLANID=2}.Bridgename.” Thus, the RPC command with at least one found instance ID is “InternetGatewayDevice.Layer2Bridging.Bridge.9999.Bridgename”. Then, the executing module 308 executes the RPC command of “InternetGatewayDevice. Layer2Bridging.Bridge.9999.Bridgename”, and responds “InternetGatewayDevice. Layer2Bridging.Bridge.9999.Bridgename=“TEST-BRIDGE”” to the ACS 10.

In conclusion, the CPE 30 receives one RPC command with at least one search condition from the ACS 10, replaces the at least one search condition with at least one found instance ID, and then executes the RPC command with the at least one found instance ID. Thus, the ACS 10 can use only one RPC command with at least one search condition to manage the CPE 30, which is very easy and convenient.

While various embodiments and methods of the present disclosure have been described, it should be understood that they have been presented by example only and not by limitation. Thus the breadth and scope of the present disclosure should not be limited by the above-described embodiments, but should be defined only in accordance with the following claims and their equivalents.

What is claimed is:

1. A customer premises equipment (CPE) communicating with an auto-configuration server (ACS), the CPE comprising a data model comprising a plurality of instances, each instance comprising at least one parameter with at least one parameter value and an instance identifier (ID) corresponding to the at least one parameter with the at least one parameter value, the CPE comprising:
at least one processor;
a storage system; and
one or more programs that are stored in the storage system and are executed by the at least one processor, and the one or more programs comprising:
a communication module operable to receive a remote procedure call (RPC) command comprising at least one search condition from the ACS, the at least one search condition comprising at least one parameter with at least one parameter value;
a searching module operable to search the data model to find at least one instance ID corresponding to the at least one search condition;
a replacing module operable to replace the at least one search condition of the RPC command with at least one found instance ID; and
an executing module operable to execute the RPC command with the at least one found instance ID.

2. The CPE of claim 1, wherein the communication module is further operable to establish a transport control protocol connection with the ACS.

3. The CPE of claim 1, wherein the at least one search condition further comprises symbols “{” and “}”.

4. The CPE of claim 1, wherein the communication module is further operable to determine whether the RPC command with the at least one condition is supported by the CPE, and discard the RPC command with the at least one search condition when the RPC command with the at least one condition is not supported by the CPE.

5. The CPE of claim 1, wherein the storage system stores the at least one search condition, and the searching module reads the at least one search condition and searches the data model to find at least one instance ID corresponding the at least one search condition.

6. The CPE of claim 5, wherein the replacing module replaces the at least one search condition stored in the storage system with the at least one found instance ID, and then replaces the at least one search condition of the RPC command with the at least one found instance ID stored in the storage system.

7. The CPE of claim 1, wherein the executing module is operable to determine whether parameters of the RPC command with the at least one found instance ID are correct, and discard the RPC command with the at least one found instance ID when the parameters of the RPC command with the at least one found instance ID are wrong.

8. A method for processing commands of a customer premises equipment (CPE), the CPE communicating with an auto-configuration server (ACS), the CPE comprising a data model comprising a plurality of instances, each instance comprising at least one parameter with at least one parameter value and an instance identifier (ID) corresponding to the at least one parameter with the at least one parameter value, the method comprising:
receiving a remote procedure call (RPC) command with at least one search condition from the ACS, the at least one search condition comprising at least one parameter with at least one parameter value;
searching the data model to find at least one instance ID corresponding to the at least one search condition;
replacing the at least one search condition of the RPC command with the at least one found instance ID; and
executing the RPC command with the at least one found instance ID.

9. The method of claim 8, further comprising: establishing a transport control protocol connection with the ACS.

10. The method of claim 8, wherein the at least one search condition further comprises symbols “{” and “}”.

11. The method of claim 8, further comprising: determining whether the RPC command with the at least one search condition is supported by the CPE, and discarding the RPC command with the at least one search condition not supported by the CPE.

12. The method of claim 8, further comprising: storing the at least one search condition in a storage system.

13. The method of claim 12, wherein the searching step comprises:
reading the at least one search condition from the storage system; and
searching the data model to find at least one instance ID corresponding to the at least one read search condition.

14. The method of claim 13, wherein the replacing step comprises:
replacing the at least one search condition stored in the storage system with the at least one found instance ID; and
replacing the at least one search condition of the RPC command with the at least one found instance ID stored in the storage system.

15. The method of claim 8, further comprising:
determining whether parameters of the RPC command with the at least one found instance ID are correct; and
discarding the RPC command with the at least one found instance ID if the parameters of the RPC command with the at least one found instance ID are not correct.
